(19) United States
(12) Patent Application Publication
(10) Pub. No.: US 2015/0370340 A1
(43) Pub. Date: Dec. 24, 2015

(54) NEW COMPUTER KEYBOARD LAYOUT, STRUCTURE AND ARRANGEMENT

(71) Applicant: Marco PAPALIA, Genova (IT)

(72) Inventor: Marco PAPALIA, Amsterdam (NL)

(21) Appl. No.: 14/761,948

(22) PCT Filed: Jan. 10, 2014
(86) PCT No.: PCT/IT2014/000009

§ 371 Date: Jul. 20, 2015

(30) Foreign Application Priority Data
Jan. 18, 2013 (IT) GE2013A000007

(51) Int. Cl. G06F 3/02; G06F 3/0488; G06F 1/16

(52) U.S. Cl. CPC G06F 3/0216; G06F 1/1664; G06F 3/0219; G06F 3/04886

(57) ABSTRACT

The invention provides a way to optimize and increase typing speed for smartphones during SMS or mail writing given that the existing methods are not optimized and they often cause difficulties, limitations or slow text insertion. The technical problem to solve is “to develop an intelligent keyboard that is fast and intuitive, designed for devices using either a touchscreen keyboard (cell phones, smartphones and tablets as well as ticket emission machines, ATM machines, etc.) or a physical keyboard (many smartphones, old generation cell phones), which are used mostly with a single hand or even with a single finger in case of smaller devices”. The solution to this problem originates from blending together the following ideas: •1) Creation of a new, well proportioned layout featuring hexagonal cells that is designed to diminish the distance traveled by the finger in order to reach all the keys in order to increase the typing speed; •2) Study of cryptoanalysis, i.e. the use frequency of letters in different languages. Deciding the position of the letters in the above layout in an intelligent way visibly improves the efficiency, the intuitive use and speed of use as well as the use of intuitive and innate mechanisms of our brain such as mental associating and linking •3) Completely changing the classic QWERTY layout by moving the space key in the center of the new ad-hoc created layout and adding a bigger number of alphanumeric symbols thanks to the easily interchangeable supplementary layouts having the same structure. Application of this invention ranges from telecommunications to any industrial appliance having a virtual keyboard, from teaching to information exchange.

### 1) INTRODUCTION

The specific purpose of this short introduction is to give a generic point of view on history, types and methods employed in keyboard implementation in the past as well as the technological evolution of the associated devices. It is a prelude to the main reasons that brought to the creation of this product.

The first alphanumeric schemes for keyboards go back to 1864 when Christopher Sholes conceived the QWERTY layout (the most popular layout for keyboards in the world today). The patent was sold to Remington and Son, a company producing writing machines, in 1873 and its commercialization was a great success. Sholes had observed that, in order to prevent the writing machine from getting clogged, a good strategy was to position the most used letters at a greater distance and divide them into two main groups, dedicating one hand to each group. This brought to a considerable increase of the writing speed and a decrease of typographic error rate thanks to the smart letter arrangement combined with the hand positioning and applied pressure. The QWERTY layout caused an authentic revolution to the writing machine world; it was used constantly ever since 1873 and it was next adopted in the personal computers and in the most recent electronic devices.

One hundred years later the large-scale introduction of first generation mobile phones represented a great challenge for the QWERTY layout; the devices limited size made it almost impossible to employ its use. Hence it was substituted by alternative text input methods for short messages (SMS), the new global communication method developed in that period and currently the most popular communication method (in 2012 an average of 10 billion SMS were sent each day). The adopted solution for the composition of these messages was associating a number of letters to each key on the numeric keyboard and multi-tapping the same key (one to four times) to select the desired letter. As a result, typing words and composing phrases took much longer and typographical error rates increased. To overcome these limits an optimization method for text input was implemented: the Text on 9 keys (T9) method used a preloaded dictionary to predict the words being typed in order to speed up message writing. This software and other similar solutions notably decreased text input time even though they did not represent a new keyboard layout.

In 2007 Apple gave birth to iPhone, introducing the touch screen interface and completely reinventing mobile phones. From that moment on all other electronic industries followed the lead and mobile phones became smartphones and tablets: multifunctional devices that could be used for reading books, writing and sending e-mails (longer and more complex entities than SMS), web navigation, watching movies, listening to music, etc. To satisfy these requirements, more generous-sized screens were introduced in the devices and this made it possible for the QWERTY layout to come back once more in the device market keeping its original structure. The smartphone and tablet advent became a global success and it constantly substituted old-fashioned mobile phones up to the present days.

### 1.1 Problem Statement

There are herein no objections about the efficacy of the QWERTY layout. It is a fact though, that it was projected for machines intended to be used with both hands and all ten fingers, not for devices that are used with one hand or a single finger. The human brain, and our hands as a consequence, can easily react and adapt to changes, but the author believes that conceiving a new, faster, efficacious and more intuitive method could lead to a remarkable improvement in the technological ambit as well as the physical and mental one, exploiting our brain's associative links and the spatial centrality concept.

These are the main motivations that pushed towards this work and its result, denominated Keybee. It is a new keyboard layout, optimized for touchscreen devices such as smartphones, tablets, ticket emission machines, cash machines and similar appliances using either a physical or virtual keyboard. It was designed to be optimally used with one hand or a single finger (giving the comfort of having a free hand), exactly the way these objects were thought to be used when they were projected.

### 2) PRODUCT DESCRIPTION

### 2.1 Structure:

The structure of this novel layout takes inspiration from the beehive construction model. It is believed that, in order to optimize space within their hive, bees instinctively have been using hexagonal shapes for millions of years (the motivation is not scientifically confirmed though). A hexagon is a simple, precise, symmetrical shape that offers an extraordinary efficiency level: it provides optimized links with the adjacent cells and proportionally maximizes the space each cell occupies. The reasons why this shape was adopted for the Keybee layout are the same: key area and key adjacency and links optimization. Compared to a rectangular or square key shape each key has more adjacent cells in the Keybee layout, globally resulting in a homogeneous and well proportioned keyboard. Furthermore, this disposition allows shorter maximum distances between letters located far from each-other; in order to reach the furthest letter from a specific cell taken into consideration, we can notice that the number of cells needed to be crossed is lower (i.e. the distance traveled by the finger while typing is shorter) compared to the QWERTY model.

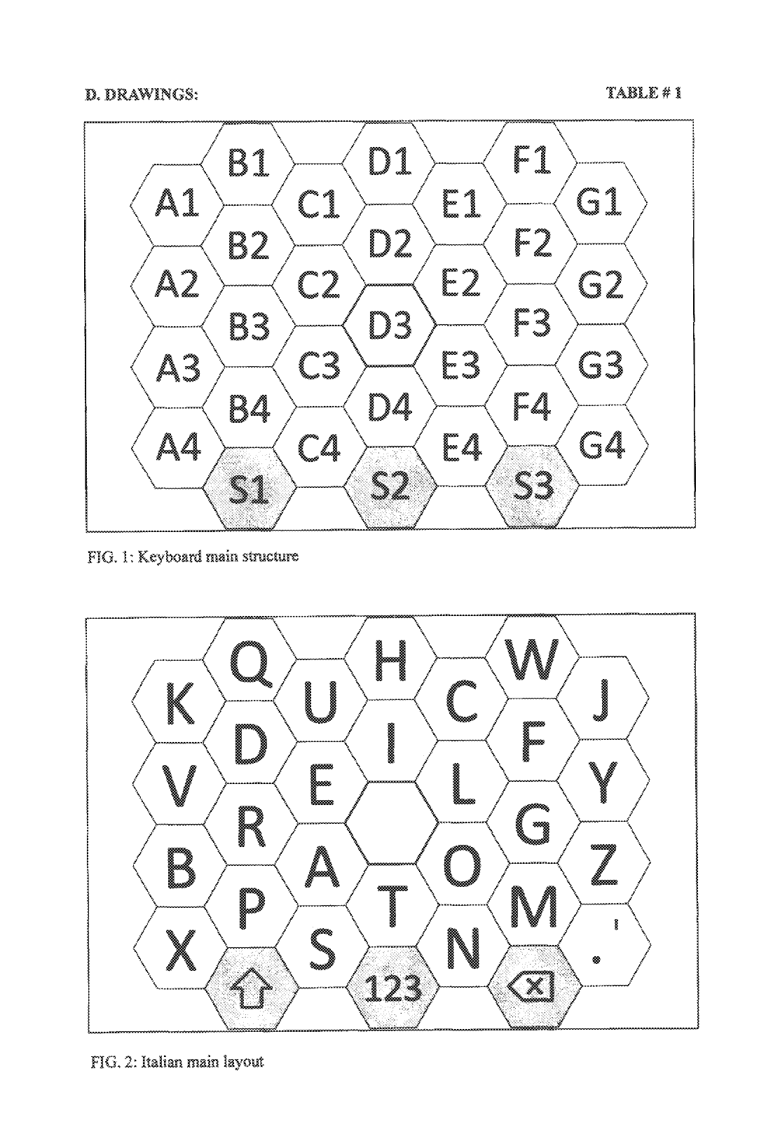

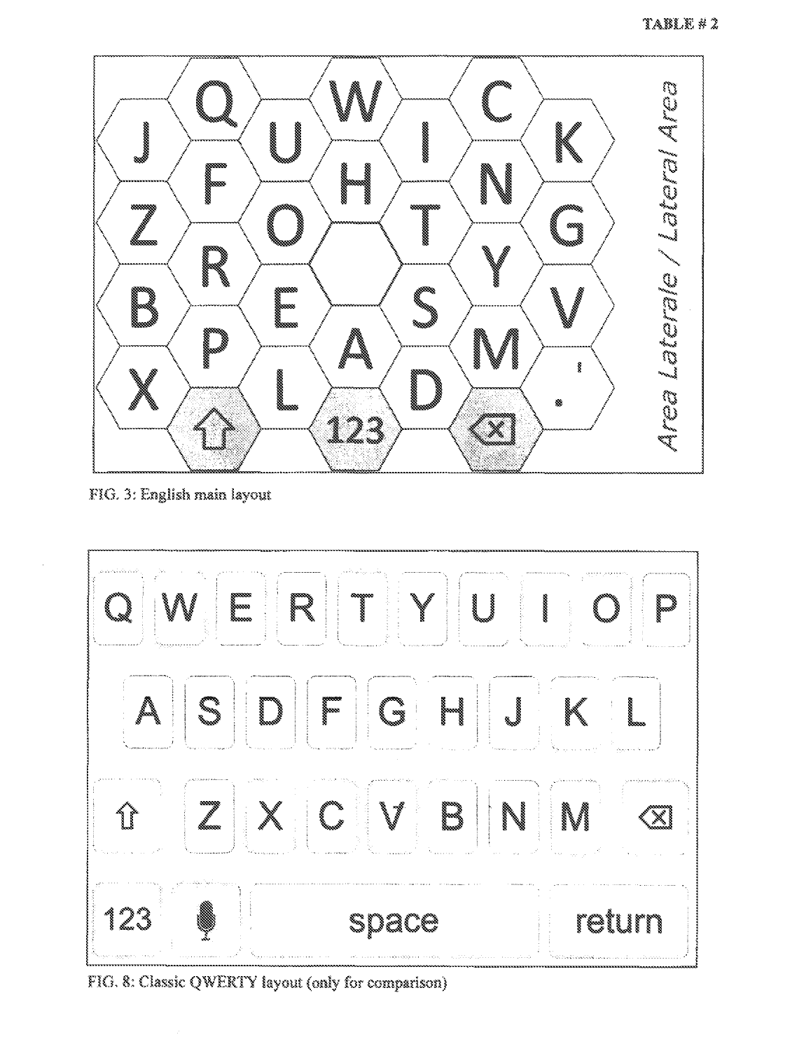

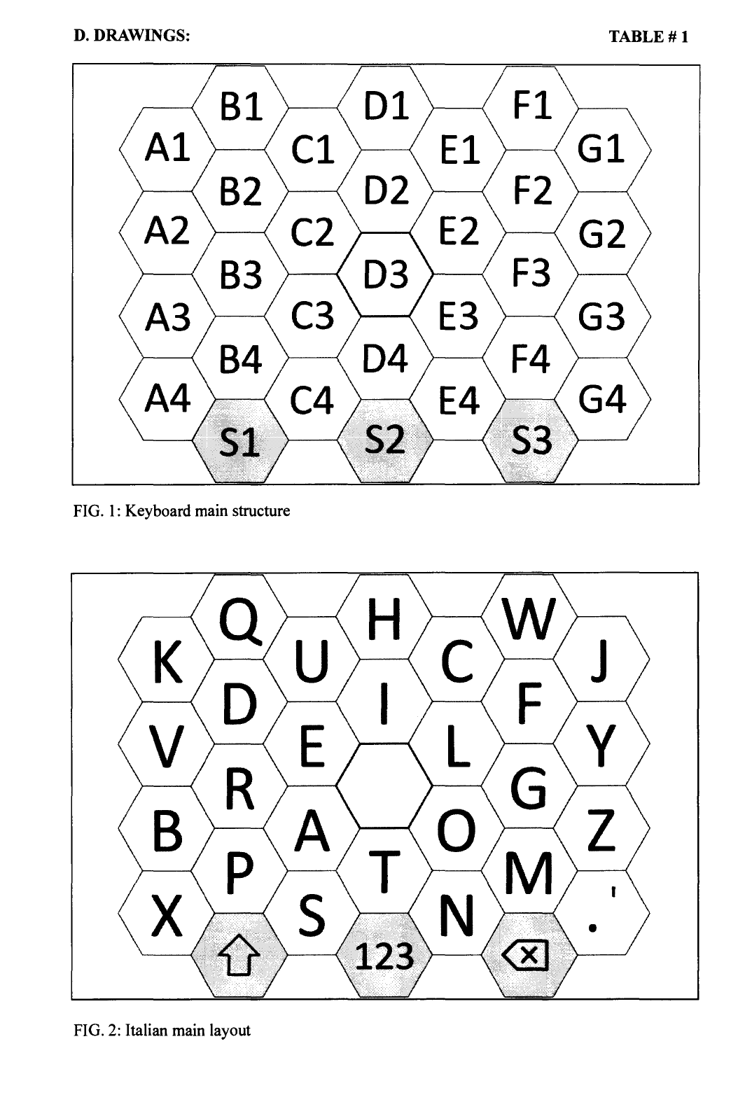

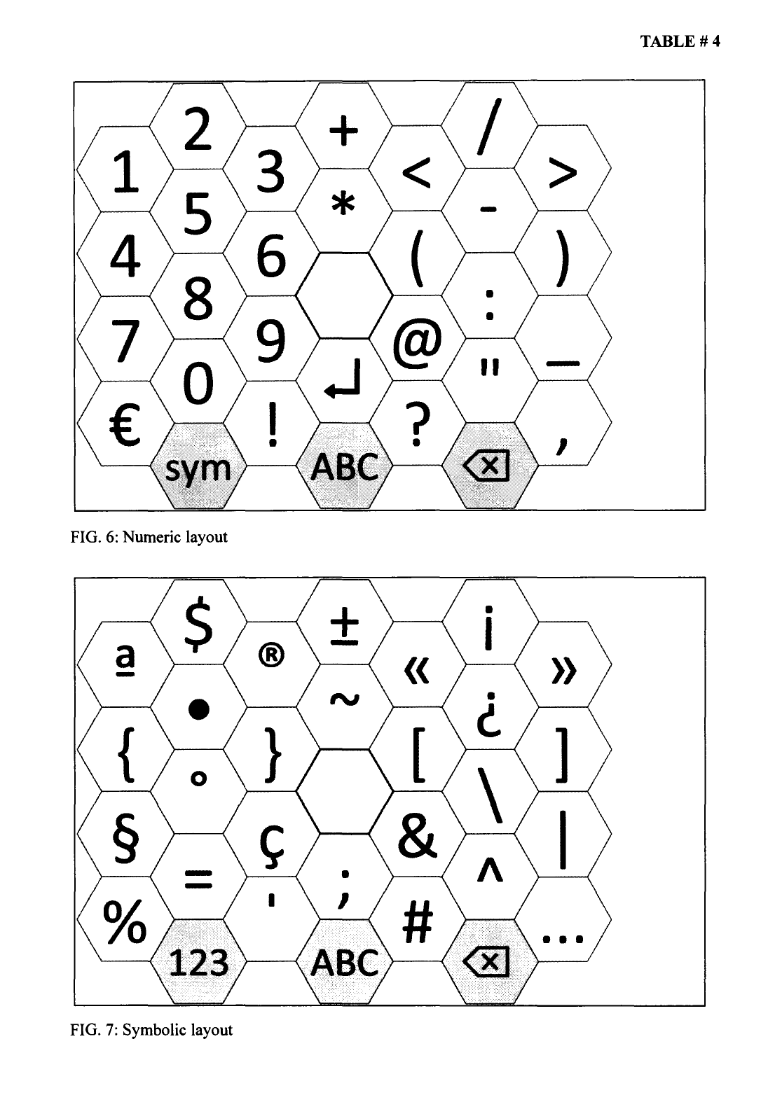

The cell number and disposition in the Keybee layout was decided based on the English alphabet, including its 26 letters and the main punctuation symbols needed to write a complete phrase without having to change the keyboard layout. There are hence 31 regular hexagonal cells, their base parallel to the horizontal plane and the resulting grid has seven alternate columns following the 4-5-4-5-4-5-4 scheme, with each figure indicating the number of cells per column (FIG. 1). Other than the main language layout, there are two additional ones: a numeric layout (FIG. 6) and a symbolic one (FIG. 7) presenting the same structure. The former layout includes the numbers and other important symbols, the latter displays the secondary symbols for a total of 82 characters and alphanumeric symbols displayed in three interchangeable keyboard layouts.

### LEGEND AND DENOMINATIONS FOR A BETTER UNDERSTANDING

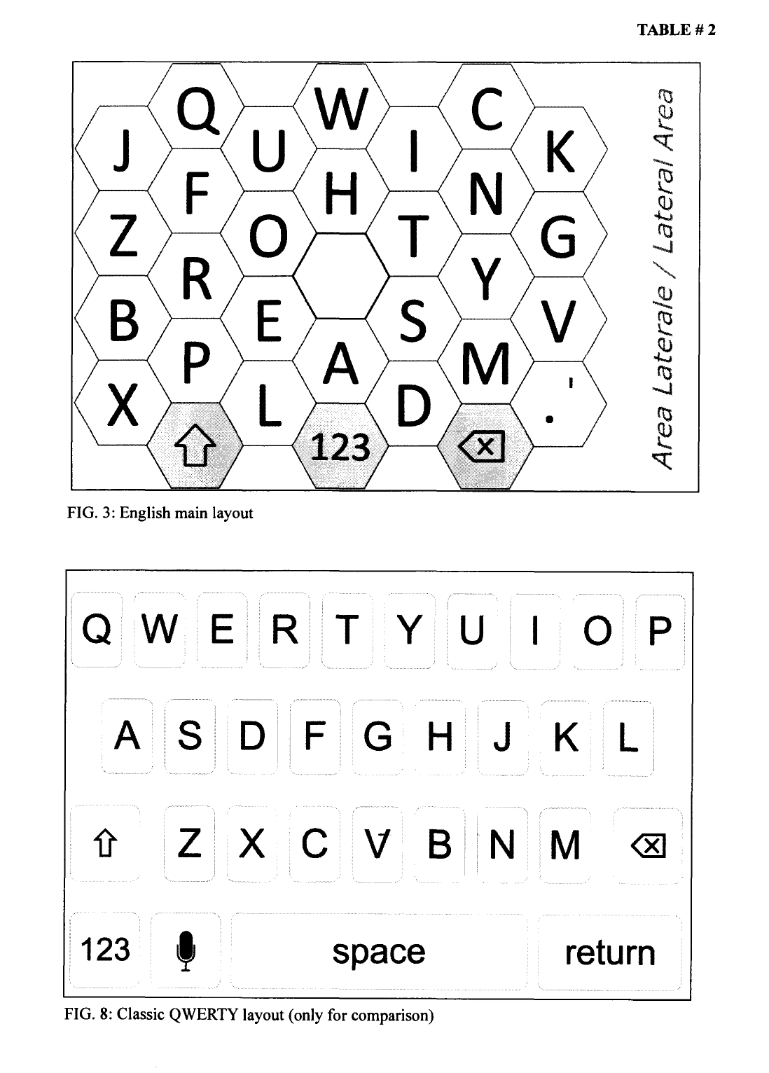

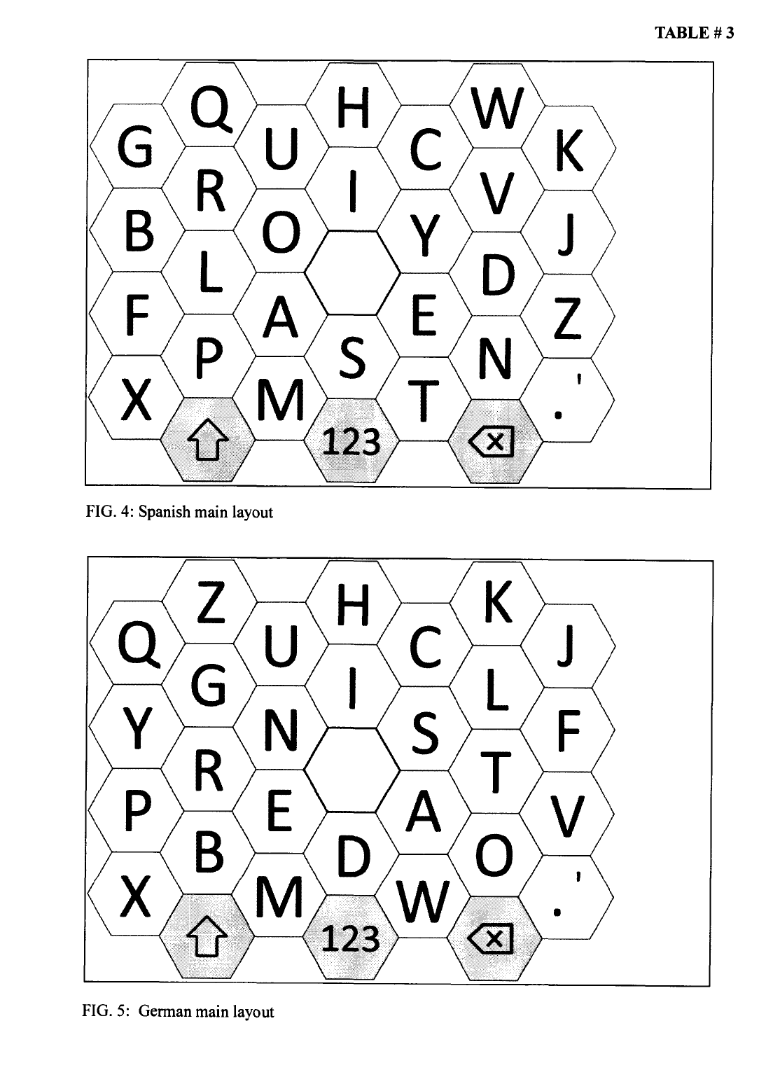

KB=KeyBee (FIG. 1) Keyboard main structure
KBLi=KeyBeeLetters Italian (FIG. 2) Italian main layout
KBLe=KeyBeeLetters English (FIG. 3) English main layout
KBLs=KeyBeeLetters Spanish (FIG. 4) Spanish main layout
KBLg=KeyBeeLetters German (FIG. 5) German main layout
KBN=KeyBeeNumbers (FIG. 6) Numeric layout
KBS=KeyBeeSymbols (FIG. 7) Symbolic layout

### CHR=Center Hexagonal Ring

To better comprehend the hexagonal structure scheme, a code composed of one letter and one number is associated to each cell (FIG. 1).

From cell A1 to cell G3 the alphabet letters are assigned with few exceptions that will be explained in the following paragraphs. Thanks to the hexagonal structure of the layout, most of the cells have a number of adjacencies that follow the scheme below. This disposition allows the finger to reach adjacent cells as well as further ones in a faster and more efficient way (FIG. 1).

B2, B3, F2, F3 and D3 making up 18% of all cells, have six adjacent cells containing letters
C1, E1, B4, F4, D2 E2, E3, D4, C3, C2 making up 37% of all cells, have five adjacent cells containing letters
A2, A3, G2, G3 making up 15% of all cells, have four adjacent cells containing letters
B1 D1, F1, E4, C4, A1, G1 making up 26% of all cells, have three adjacent cells containing letters
A4 making up 4% of all cells, has two adjacent cells containing letters
S1, S2, S3 special cells, more on this later
2.3 More intelligent means faster:

Once the central key was decided, the next step was to define the Central Hexagonal Ring, from here on referred to as CHR, and the special keys S1, S2 and S3.

The CHR is composed of cells D2, E2, E3, D4, C3, C2, all being adjacent to the central D3 key and having a maximum distance of four steps from any other cell. Every CHR cell has other five adjacent cells; it is easy to conclude that these cells are assigned to the most frequently used letters as well as the ones that can best exploit the minimum distance from the space key. Next to the CHR cells can be placed letters that do not require minimum distance from the space key, i.e. letters that are usually found within words and less frequently at the end. The most peripheral cells are finally assigned to less frequently used letters in order to respect the spatial centrality principle: the lower the frequency of the letter, the further it is placed from the center. The special keys S1, S2 and S3 are positioned in the lower part of the layout and they have few adjacent cells, which attributes them a relative importance in the typing process. This positioning makes them suitable for special functions regardless of text typing. More precisely, the chosen functions for these keys were: the shift/change letter (S1), the swap/change keyboard (S2) and the delete (S3) functions.

To sum up, increasing the typing speed means to decide the letters' distance from the center based on their use frequency and to arrange them properly in order to facilitate the writing of the most frequently occurring patterns in the language taken into consideration.

### 2.4 Letter Position and Frequency:

In the present work the author has considered the layout optimization for Italian, English, Spanish and German languages. Other layouts for French, Portuguese, Arabic, Balkan and Slavic languages will be studied in the near future while waiting for the patent approval/acceptance. In fact, every language has a different letter frequency and syllable construction approach, as well as different relations and interactions between vowels and consonants. In the present optimization of letter disposition the following language aspects were considered: verb forms, preposition frequency, pronouns and conjunctions, plural forms and their use, most used linguistic forms, apostrophe use, most used word groups, prefixes and suffixes of most frequent words.

Frequency of letters in the Italian language in descending order (in %):

### E(11.79) A(11.74) I(11.28) O(9.83) N(6.90) L(6.51) R(6.37) T(5.62) S(4.98) C(4.50) D(3.73) P(3.05) U(3.01) M(2.51) V(2.10) G(1.64) H(1.54) F(0.95) B(0.92) Q(0.51) Z(0.49)

Frequency of letters in the English language in descending order (in %):

### E(12.70) T(9.06) A(8.17) O(7.51) I(6.97) N(6.74) S(6.33) H(6.09) R(5.99) D(4.25) L(4.02) C(2.78) U(2.76) M(2.41) W(2.36) F(2.23) G(2.01) Y(1.97) P(1.93) B(1.49) K(0.77) V(0.98) X(0.15) J(0.15) Q(0.09) Z(0.07)

Frequency of letters in the Spanish language in descending order (in %):

### E(13.68) A(12.53) O(8.68) S(7.98) R(6.87) N(6.71) I(6.25) D(5.86) L(4.97) C(4.68) T(4.63) U(3.93) M(3.15) P(2.51) B(1.42) G(1.01) V(0.90) Y(0.90) Q(0.88) H(0.70) F(0.69) Z(0.52) J(0.44) X(0.22) W(0.02) K(0.01)

Frequency of letters in the German language in descending order (in %):

### E(17.40) N(9.78) I(7.55) S(7.27) R(7.00) A(6.51) T(6.15) D(5.08) H(4.76) U(4.35) L(3.44) C(3.06) G(3.01) M(2.53) O(2.51) B(1.89) W(1.89) F(1.66) K(1.21) Z(1.13) P(0.79) V(0.67) J(0.27) Y(0.04) X(0.03) Q(0.02)

KBLitalian (Italian main layout FIG. 2)

### CELL: LETTER

### A1: K

### A2: V

### A3: B

### A4: X

### B1: Q

### B2: D

### B3: R

### B4: P

C1: U adjacent to the Q because the Q is always followed by the U
C2: E inside the CHR.
C3: A inside the CHR.

### C4: S

D1: H adjacent to the H because the C is often followed by the H
D2: I inside the CHR.
D3: space
D4: T inside the CHR.

### E1: C

E2: L inside the CHR.
E3: O inside the CHR.

### E4: N

### F1: W

### F2: F

F3: G close to the L because are frequent the constructs with gl

### F4: M

### G1: J

### G2: Y

### G3: Z

G4: . (dot) in normal mode; ' (apostrophe) in SHIFT mode
S1: SHIFT upper/lower case of KBLi
S2: swap to KBN
S3: delete
KBLenglish (English main layout FIG. 3)

### CELL: LETTER

### A1: J

### A2: Z

### A3: B

### A4: X

### B1: Q

### B2: F

### B3: R

### B4: P

C1: U adjacent to the Q because the Q is often followed by the U
C2: O inside the CHR.
C3: E inside the CHR.

### C4: L

D1: W adjacent to the H because the construct wh is frequently used
D2: H inside the CHR and close to the T because the th is frequently used
D3: space
D4: A inside the CHR.

### E1: I

E2: T inside the CHR.
E3: S inside the CHR.

### E4: D

### F1: C

F2: N adjacent to the I because are frequent the -ing verbal compost

### F3: Y

### F4: M

G1: K adjacent to the C because the construct ck is often used
G2: G adjacent to the N because are frequent the -ing verbal compost

### G3: V

G4: . (dot) in normal mode; ' (apostrophe) in SHIFT mode
S1: SHIFT upper/lower case of KBLe
S2: swap to KBN
S3: delete
KBLspanish (Spanish main layout FIG. 4)

### CELL: LETTER

A1: G adjacent to the R because are frequent the constructs with gr

### A2: B

### A3: F

### A4: X

### B1: Q

### B2: R

### B3: L

### B4: P

C1: U adjacent to the Q because the Q is alway followed by the U
C2: O inside the CHR.
C3: A inside the CHR.

### C4: M

D1: H adjacent to the H because the C is often followed by the H
D2: I inside the CHR.
D3: space
D4: S inside the CHR.

### E1: C

E2: Y inside the CHR.
E3: E inside the CHR.

### E4: T

### F1: W

### F2: V

### F3: D

### F4: N

### G1: K

### G2: J

### G3: Z

G4: . (dot) in normal mode; ' (apostrophe) in SHIFT mode
S1: SHIFT upper/lower case of KBLs
S2: swap to KBN
S3: delete
KBLgerman (German main layout FIG. 5)

### CELL: LETTER

### A1: Q

### A2: Y

### A3: P

### A4: X

### B1: Z

### B2: G

### B3: R

### B4: B

C1: U adjacent to the Z because the Z is often followed by the U
C2: N inside the CHR.
C3: E inside the CHR.

### C4: M

D1: H adjacent to the H because the C is often followed by the H
D2: I inside the CHR.
D3: spazio
D4: D inside the CHR.

### E1: C

E2: S inside the CHR.
E3: A inside the CHR.

### E4: W

### F1: K

### F2: L

### F3: T

### F4: O

### G1: J

### G2: F

### G3: V

G4: . (dot) in normal mode; ' (apostrophe) in SHIFT mode
S1: SHIFT upper/lower case of KBLg
S2: swap to KBN
S3: delete
KBN (Numeric layout FIG. 6) KBS (Symbolic layout FIG. 7)
CELL: number/symbol CELL: symbol

### A1: 1 A1: ^{a}

### A2: 4 A2: {

### A3: 7 A3: §

A4: [symbol] currency A4: %
B1: 2 B1: $ other currency

### B2: 5 B2: •

### B3: 8 B3: ∘

### B4: O B4: =

### C1: 3 C1: ®

### C2: 6 C2: }

### C3: 9 C3: ç

### C4: ∇ C4: '

### D1: + D1: ±

### D2: * D2: ˜

D3: space D3: space
D4: return D4: ;

### E1: <E1: <<

### E2: (E2: [

### E3: @ E3: &

### E4: ? E4: #

### F1: / F1:

### F2: −F2:

### F3: F3: \

F4: “F4: ̂

### G1: >G1: >>

### G2:) G2: ]

### G3: − G3: |

### G4: ' G4: . . .

S1: swap to KBS S1: swap to KBN
S2: swap to KBL S2: swap to KBL
S3: delete S3: delete

### 2.5 Remarks on KBLi, KBLe, KBLs, KBLg, KBN e KBS:

1. The CHR letters were positioned as previously explained for two reasons: they have a high frequency in the language taken into consideration and they are found at the beginning or the end of most words.
2. The SHIFT command performs the usual Uppercase/Lowercase toggle function for the keyboards and shows the apostrophe in cell G4.
3. In the KBLi many of the most frequent letter compositions such as pronouns, prepositions, etc., were grouped together as much as possible because of their high use rate in a text (di, da, del, dei, chi, che, ch-, ci, con, qu-, qui, qua, in, per, il, lo, la, gli, le, lei, lui, ne, no, non, noi, nel, nei, se, -sa-, -so, br-, pr, fi-, are, ere, ire, st-, -ta, -to-, -ant-). They are positioned in a compact region at distance one or two steps, allowing fast typing of these constructs.
4. In the KBLe many of the most frequent letter compositions such as pronouns, prepositions, etc., were grouped together as much as possible because of their high use rate in a text (as, at, in, are, be, it, is, he, ha-, hi-, she, of, or, for, our, my, to, -th-, the, wh-, -ch, -ck, -ing, -ad, -ed, qu-, br-, pr-, fr-, pl-, sa-, sy-, -ty-, -st, -nt, -ny), all positioned at a one- or two-step distance.
5. In the KBLe the letters M, S, V, D were positioned next to the apostrophe since they are most often using this character for personal contractions (I'm), Saxon genitive and other contractions (yours, it's), contractions of verbs in present perfect tense (I've, I′d).
6. In the KBLs many of the most frequent letter compositions such as pronouns, prepositions, etc., were grouped together as much as possible because of their high use rate in a text (as, es, et, ma, mas, de, -y-, -gr-, al, -la-, -pa-, -ap, bl-, ch-, qu-, -nt, -os, -mo-, ol, fr-, gu, -ne-, pal-, -ns, st-, bo-, fa), all positioned at a one- or two-step distance.
7. In the KBLg many of the most frequent letter compositions such as pronouns, prepositions, etc., were grouped together as much as possible because of their high use rate in a text (as, at, un, nu, ur, da, de, der, -ung, sch, wa-, wo-, we-, -ei-, ie-, sc, sh-, ch-, gu-, zu-, vo-, fl-, pr-, br-, er, -ck, sk-, st-), all positioned at a one- or two-step distance.
8. Letters having accent marks and other little used symbols can be inserted using an alternative key pressing mode: double click, swipe, long click, flung click, etc.

### 2.6 Ergonomics:

The Keybee layout, thanks to its special proportionality, offers a better ergonomics on the device screen on which it is being used. Its structure was carefully examined to obtain a 1:3 proportionality (length to height ratio of the keyboard), which is exactly the proportion obtained by measuring the length and height of a closed fist. In a landscape orientation of the device all the letters will result to be easily reachable with a single hand, improving in this way the typing process (recall that many devices such as tablets or ticket emitting machines are almost exclusively used with a single hand). On the other hand, in a portrait orientation of the device (think about typing with the thumbs on a smartphone, which is the most usual position) the proportion becomes 1:5 thanks to the possibility of inserting an empty area laterally. This idea was thought to prevent the thumb from tapping keys that are too near to the border too often, which is not a natural position (FIG. 3). This area can be exploited to insert commands that are useful but not needed often: settings, send, change language, etc. Moreover, the cell area in the present layout is bigger than actual standard layouts from 30% to 50% and this provides a better visualization of the letters, resulting in lower typographical error rates.

### 2.7 Main Advantages of Keybee on the Standard QWERTY Model:

Shorter times required for text composition: the result was obtained from an experiment comparing the keyboards in FIG. 2 (Italian main layout), in FIG. 3 (English main layout), in FIG. 4 (Spanish main layout), in FIG. 5 (German main layout) and in FIG. 8 (classic QWERTY layout). The same area was dedicated to all layouts, then measurements of the distance from the center of each key to the center of every other key, for a total of 378, were performed. Next, the distance traveled by the finger in cm was computed during the typing of very frequent words and long texts in each of the before mentioned languages using the Keybee and then the QWERTY layout. The results show that, for very frequent words in each language the Keybee layout has a remarkable advantage: there are peaks of 60% reduction of the traveled distance, while for long texts there is a reduction of 40%. This is the proof that a reduction of the distance automatically causes a reduction in text entry times.
Bigger key area and letters: by measuring the letter size on each scheme we notice that the Keybee layout presents letters that are 30% bigger than a QWERTY layout occupying the same screen portion. The advantage goes up to 50% if we consider the whole screen.
Lower number of screen taps to type a given text: in the former experiment the number of screen taps necessary to input text was also considered, given that it is not necessary to lift the finger from the screen to type in adjacent letters, swiping is sufficient. The results show that, given the same number of characters to insert, the Keybee layout requires 50% less screen taps compared to the QWERTY layout.
   2.8 Other Advantages with Respect to the QWERTY Model:
Higher speed for text writing with a single finger (smartphones and small-sized screens);
Higher speed for text writing with a single hand (tablets and bigger-sized screens);
Higher speed for interchanging among the alphabetic, numerical and symbolic layouts;
Once the layout is changed, a single tap on the screen is enough to reach any other key;
Higher number of alphanumeric symbols present in the three keyboard layouts (17% more symbols);
Lower probability to make typographic errors;
More adjacent letters for each key thanks to the hexagonal structure;
Better distribution of letters, syllables, common constructs and groups having letters in common based on their use frequency;
Changing the keyboard language is straightforward;
Better ergonomics in the device use since all letters are more easily reachable with a single finger;
The keyboard shows a better adaptability on small- and big-sized screens thanks to its proportionality;
Better use of the space left free from the keyboard both in portrait and landscape orientation in tablets and similar devices;
The high speed for text insertion is reached without the help of preloaded algorithms that predict or autocomplete words.

### 2.10 State of the Art and Previous Research Report:

Based on a previous research report (Prot No. 177475), obtained after filing the Italian National request having the identification number GE2013A000007, three patents were found to be similar to the present:
1) US574060A filed on Jul. 25, 1998 (denominated in D1 keyboard report)
2) EP1126364A1 filed on Aug. 22, 2001 (denominated in D2 keyboard report)
3) CN1504865A filed on Jun. 16, 2004 (denominated in D3 keyboard report)

Despite the similarities, there was a positive appraisal on innovation and industrial application. A negative opinion concerned the creative point of view, taking into account the hexagonal structure alone and not the intelligent letter disposition based on the linguistic use rates as claimed. Therefore the author wishes to attach a synthesis of his reply to the above evaluation:

“The author is aware that a hexagonal structure for keyboards created for touch screens lacks in inventiveness, but he believes that in the present context it can be considered as such. The goal of the present product is, in fact, to increase the text entry speed in touchscreen devices starting from a space-optimizing structure in small-sized displays (e.g. smartphones), combining it with a letter disposition that reduces the number of screen taps necessary to insert text. These two aspects have to be analyzed jointly, otherwise the advantage of the whole invention is bounded. The letter disposition of this product was an important point of in-depth studying process: the final position of each letter is a result of this process, it derives from the careful study of use rates in every language taken into consideration, excluding any random contribution in the decision making.
Letters in the D1 and D2 keyboards referenced above do not present a particular disposition: D1 follows the Latin alphabet; D2 even lacks some important letters.
The negative evaluation concerning creativity as stated in the Research Report (Item V, points 5, 6, 7 and 8) does not take into account the claimed letter disposition (claims 3-6), it is exclusively based on the keyboard structure (claims 1-2).
In conclusion, the author thinks that an expert of the field could modify the structure starting from D1 or D2 or D3 keyboards as cited above without applying any inventive activity, but he/she could not obtain a higher text emission speed without optimizing the letter disposition on the chosen structure, and that is the point where he/she actually becomes inventive.”

1) Keyboard layout for touchscreen devices having a structure (1) composed of 31 hexagonal cells with their base parallel to the horizontal plane, tassellated and arranged in seven columns with four or five cells each. The four-cell and five-cell columns alternate. They follow the 4-5-4-5-4-5-4 pattern, where each figure corresponds to the cell number per column. Starting from the left (1), the first column is composed of cells A1, A2, A3, A4: the second column is composed of cells B1, B2, B3, B4, S1; the third column is composed of cells C1, C2, C3, C4; the fourth column is composed of cells D1, D2, D3, D4, S2; the fifth column is composed of cells E1, E2, E3, E4; the sixth column is composed of cells F1, F2, F3, F4, S3; the seventh column is composed of cells G1, G2, G3, G4.

2) Claim concerning the position of the white space key in the center of the structure (1) described in claim 1. The space key claims the D3 key, i.e. the very center of the keyboard.

3) Claiming the character's arrangement layout in Italian (2) in the structure (1) as described in claim 1 according to the scheme (CELL: LETTER):
A1: K, A2: V, A3: B, A4: X
B1: Q, B2: D, B3: R, B4: P, S1: shift (change letter)
C1: U, C2: E, C3: A, C4: S
D1: H, D2: I, D3: space key, D4: T, S2: change keyboard
E1: C, E2: L, E3: 0, E4: N
F1: W, F2: F, F3: G, F4: M, S3: delete
G1: J, G2: Y, G3: Z
G4: . (dot in normal mode), ' (apostrophe in shift mode)

4) Claiming the character's arrangement layout in English (3) in the structure (1) as described in claim 1 according to the scheme (CELL: LETTER):
A1: J, A2: Z, A3: B, A4: X
B1: Q, B2: F, B3: R, B4: P, S1: shift (change letter)
C1: U, C2: O, C3: E, C4: L
D1: W, D2: H, D3: space key, D4: A, S2: change keyboard
E1: I, E2: T, E3: S, E4: D
F1: C, F2: N, F3: Y, F4: M, S3: delete
G1: K, G2: G, G3: V
G4: . (dot in normal mode), ' (apostrophe in shift mode)

5) Claiming the character's arrangement layout in Spanish (4) in the structure (1) as described in claim 1 according to the scheme (CELL: LETTER):
A1: G, A2: B, A3: F, A4: X
B1: Q, B2: R, B3: L, B4: P, S1: shift (change letter)
C1: U, C2: O, C3: A, C4: M
D1: H, D2: I, D3: space key, D4: S, S2: change keyboard
E1: C, E2: Y, E3: E, E4: T
F1: W, F2: V, F3: D, F4: N, S3: delete
G1: K, G2: J, G3: Z
G4: . (dot in normal mode), ' (apostrophe in shift mode)

6) Claiming the character's arrangement layout in German (5) in the structure (1) as described in claim 1 according to the scheme (CELL: LETTER):
A1: Q, A2: Y, A3: P, A4: X
B1: Z, B2: G, B3: R, B4: B, S1: shift (change letter)
C1: U, C2: N, C3: E, C4: M
D1: H, D2: I, D3: space key, D4: D, S2: change keyboard
E1: C, E2: S, E3: A, E4: W
F1: K, F2: L, F3: T, F4: O, S3: delete
G1: J, G2: F, G3:V
G4: . (dot in normal mode), ' (apostrophe in shift mode)

7) Claiming the main numeric layout (6) in the structure (1) as described in claim 1 according to the scheme (CELL: number/symbol):
A1: 1, A2: 4, A3: 7, A4: [symbol] (currency)
B1: 2, B2: 5, B3: 8, B4: 0, S1: change keyboard
C1: 3, C2: 6, C3: 9, C4: !
D1: +, D2: * , D3: space key, D4: return, S2: change keyboard
E1: <, E2: (, E3: @, E4: ?
F1: /, F2: −, F3: \: (colon), F4: “, S3: delete
G1: >, G2:), G3: _, G4: , (comma)

8) Claiming the secondary symbolic layout (7) in the structure (1) as described in claim 1 according to the scheme (CELL: symbol):
A1: * , A2: {, A3: §, A4: %
B1: $ , B2: •, B3: °, B4: =, S1: change keyboard
C1: ®, C2: }, C3: ç, C4: ' (apostrophe)
D1: ±, D2: ˜, D3: space key, D4: ; (semicolon), S2: change keyboard
E1: <<, E2: [, E3: & , E4: #
F1: [symbol] ; , F2: [symbol] , F3: \, F4: ̂, S3: delete
G1: , G2: ], G3: |, G4: . . .
